(19) United States
(12) Patent Application Publication
(10) Pub. No.: US 2012/0133480 A1
(43) Pub. Date: May 31, 2012

(54) OVERLOAD PROTECTION COMBINATION STRUCTURE FOR A BASE OF A FUSE

(76) Inventors: CHUN-CHANG YEN, DongGuan City (CN); Jui-Chih Yen, DongGuan City (CN)

(21) Appl. No.: 12/957,313

(22) Filed: Nov. 30, 2010

(51) Int. Cl. H01H 37/04

(52) U.S. Cl. 337/414

(57) ABSTRACT

An overload protection combination structure for a base of a fuse is provided, which is mainly directed to an improved technology of an auxiliary structure for ensuring cutoff of an overload current of the fuse base after the fuse is microminiaturized. The improvement is characterized in that, one or more recesses are formed between two leading pins of a body of the fuse base after being reduced in size, thereby increasing a creeping distance between the two leading pins for holding fuse wires, so that the microminiaturized fuse can comply with requirements of an electronic safety standard.

### BACKGROUND OF THE INVENTION

(a) Technical Field of the Invention The present invention pertains to an improved technology of a fuse structure, and more particularly to an improved technology of safety requirements for a microminiaturized fuse, so that the microminiaturized fuse can comply with requirements of an electronic safety standard.

(b) Description of the Prior Art

A fuse herein has a structure as shown in FIGS. 1 and 2, and the fuse mainly includes a base (1) composed of a body (10) and two leading wires (20) penetrating through the body (10), and a cover body (2). The two leading wires (20) penetrating through the body (10) are flattened to form leading pins (21), a group of fuse wires (30) are sandwiched therebetween, and then the base body (10) is fully covered by the cover body (2), thereby forming a complete fuse. The fuse is generally used to protect an electronic loop between electronic devices and reduce noises of various power supply circuits, such as a power supply of a television game, a handset charger, automatic equipment in an office or a factory, a household appliance, etc. As for the above-mentioned usages, the demands for a smaller and thinner power supply of a television game and a smaller and thinner mobile phone charger are increasing, so various electronic components have to be further microminiaturized to meet the requirements of the market. Of course, there is no exception for the fuse herein. However, such a further microminiaturized fuse has a reduced creeping distance between the two leading pins (21) for holding the group of fuse wires (30) and thus fails to comply with an electronic safety standard required by advanced countries. Therefore, an improvement is really necessary

### SUMMARY OF THE INVENTION

In view of the fact that a further microminiaturized fuse as described above has a reduced creeping distance between the two leading pins and thus fails to comply with an electronic safety standard required by advanced countries, the inventor ingeniously designs an overload protection combination structure for a base of a fuse after continual thinking. The present invention is mainly directed to an improved technology of an auxiliary structure for ensuring cutoff of an overload current of the fuse base after the fuse is microminiaturized. The present invention is characterized in that, one or more recesses are formed between two leading pins of a body of the fuse base after being reduced in size, thereby increasing a creeping distance between the two leading pins for holding fuse wires, so that the microminiaturized fuse can comply with requirements of an electronic safety standard.

### BRIEF DESCRIPTION OF THE DRAWINGS

FIGS. 1 and 2 are schematic structure views of a conventional fuse;

FIG. 3 is a schematic structure view of a fuse base of the present invention; and

FIG. 4 is a plan view of a fuse base of the present invention.

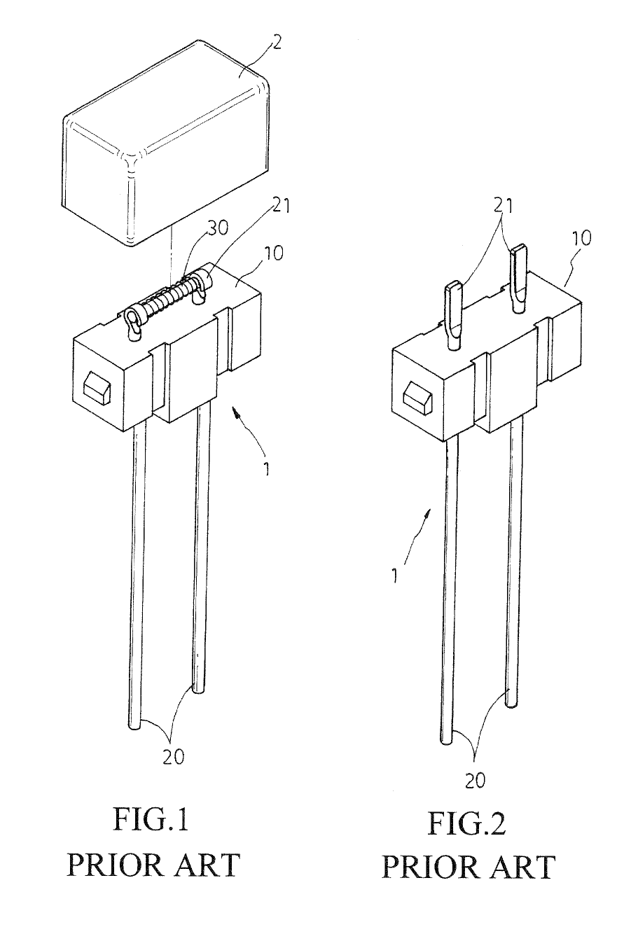

### DETAILED DESCRIPTION OF THE PREFERRED EMBODIMENTS

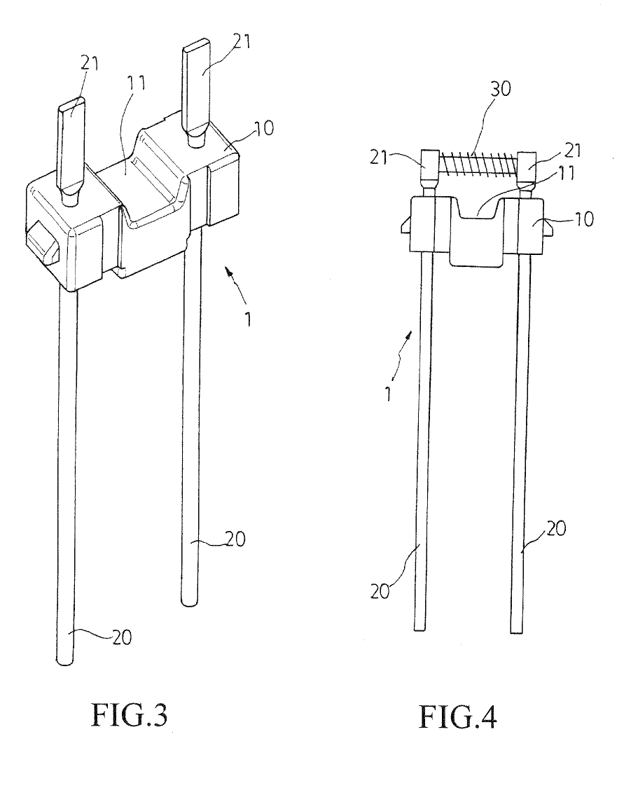

Referring to FIGS. 3 and 4, a base (1) of a fuse of the present invention is composed of a body (10) and two leading wires (20) penetrating through the body (10). The two leading wires (20) penetrating above the body (10) are flattened to form leading pins (21), and a group of fuse wires (30) are sandwiched therebetween. The improvement is characterized in that, one or more recesses (11) are formed between the two leading pins (21) of the body (10) of the fuse base (1) after being reduced in size, thereby increasing a creeping distance between the two leading pins (21) for holding the fuse wires (30), so that the microminiaturized fuse can comply with requirements of an electronic safety standard.

I claim:

1. An overload protection combination structure for a base of a fuse, the base of the fuse comprising a body and two leading wires penetrating through the body, wherein the two leading wires penetrating above the body are flattened to form leading pins, and a group of fuse wires are sandwiched therebetween; the improvement is characterized in that a recess is formed between the two leading pins of the body of the fuse base after being reduced in size, thereby increasing a creeping distance between the two leading pins for holding the fuse wires, so that the microminiaturized fuse complies with requirements of an electronic safety standard.

2. The overload protection combination structure for the base of the fuse of claim 1, wherein the recess between the two leading pins of the body has multiple forms.
